(19) United States
(12) Patent Application Publication
(10) Pub. No.: US 2019/0195425 A1
(43) Pub. Date: Jun. 27, 2019

(54) OIL AIR SUPPLY SYSTEM

(71) Applicant: OKUMA CORPORATION, Niwa-gun (JP)

(72) Inventor: Satoshi Mizuno, Niwa-gun (JP)

(21) Appl. No.: 16/191,723

(22) Filed: Nov. 15, 2018

(30) Foreign Application Priority Data
Dec. 21, 2017 (JP) 2017-245142

(51) Int. Cl. F16N 29/04; F16N 25/00; F16N 7/30

(52) U.S. Cl. CPC F16N 29/04; F16N 25/00; F16N 7/30; F16N 2250/40; F16N 2210/26; F16N 2250/04; F16N 2210/14

(57) ABSTRACT

The oil air supply system includes a lubricant oil supply pipeline, a compressed air supply pipeline, a mixing device which distributes lubricant oil supplied from the lubricant oil supply pipeline in a fixed amount and mixes the lubricant oil with compressed air to generate oil air, a plurality of oil air supply pipelines which supply the oil air to a plurality of bearings of a main spindle device respectively, a flow rate sensor provided in the lubricant oil supply pipeline and detects the flow rate of the lubricant oil, a pressure sensor provided in the compressed air supply pipeline and detects the pressure of the compressed air, and an abnormality detection device which detects supply abnormality of lubricant oil based on a detection signal output from the flow rate sensor and detects supply abnormality of compressed air based on a detection signal output from the pressure sensor.

### BACKGROUND OF THE INVENTION

### Field of the Invention

The present invention relates to an oil air supply system for supplying oil air generated by mixing lubricant oil and compressed air to a plurality of lubricating points such as bearings in, for example, a main spindle device of a machine tool, etc.

### Background Art

For example, oil air lubrication is widely used as a lubricating measure for bearings and the like in amain spindle device of a machine tool in which high speed and high accuracy are required.

Here, as an oil air supply system used in oil air lubrication, there has been known an oil air supply system which supplies lubricant oil and compressed air to a mixing device, distributes lubricant oil in a fixed amount and mixes the lubricant oil with the compressed air to generate oil air in the mixing device, and distributes and supplies the generated oil air to a plurality of lubricating points such as bearings.

In such an oil air supply system, when the supply amount of oil air is too small or too large, lubrication of bearings and the like cannot be performed stably, and there is a possibility that it becomes difficult to make the main spindle device rotate accurately.

Therefore, there is a demand for an oil air supply system having a unit which quickly detects the abnormality when an abnormality occurs in the oil air supply.

For example, JP-A-2006-258263 discloses an oil air supply system including a plurality of optical flow rate sensors which are installed in each of a plurality of oil air supply pipelines extending from a mixing device towards a plurality of lubricating points and detect the flow rate of oil particles flowing through the pipelines, and a controller which detects supply abnormality of the oil air based on detection signals output from each flow rate sensor.

### SUMMARY OF THE INVENTION

However, in the case of the oil air supply system described in JP-A-2006-258263, it is necessary to install a flow rate sensor in each of the plurality of oil air supply pipelines connecting the mixing device and the plurality of lubricating points, and thus there has been a problem of increased cost. Further, in the aforementioned system, the flow rate sensor installed in each oil air supply pipeline is an optical sensor which detects the flow rate of oil particles, and thus it is difficult to constantly perform stable detections due to contamination or deterioration in the oil air supply pipelines. In order to maintain detection accuracy, it becomes necessary to frequently perform maintenance or replacement of the oil air supply pipelines, and there has also been a problem in terms of workability.

Moreover, in the aforementioned system, the amount of lubricant oil distributed by the mixing device and flowing together with compressed air in each oil air supply pipeline is very small, and there has been a problem that it is extremely difficult to detect an abnormality by detecting an extremely minute change in the minute flow rate by the flow rate sensor.

The invention has been made in view of the aforementioned problems, and an object of the invention is to provide an oil air supply system capable of surely detecting supply abnormality of oil air to a plurality of lubricating points with a simple structure with reduced cost and less workload.

In order to achieve the aforementioned object, the invention includes the following aspects.

1) An oil air supply system, which includes

a lubricant oil supply pipeline,

a compressed air supply pipeline,

a mixing device which distributes lubricant oil supplied from the lubricant oil supply pipeline in a fixed amount and mixes the lubricant oil with compressed air supplied from the compressed air supply pipeline to generate oil air,

a plurality of oil air supply pipelines which supply the oil air to a plurality of lubricating points respectively,

a flow rate sensor which is provided in the lubricant oil supply pipeline and detects the flow rate of the lubricant oil, and

an abnormality detection device which detects supply abnormality of lubricant oil based on a detection signal output from the flow rate sensor.

2) The oil air supply system according to 1), which further includes a pressure sensor which is provided in the compressed air supply pipeline and detects the pressure of the compressed air, wherein the abnormality detection device detects supply abnormality of compressed air based on a detection signal output from the pressure sensor.

According to the oil air supply system of 1), since the flow rate sensor provided in the lubricant oil supply pipeline detects a flow rate of the lubricant oil sufficiently larger than the flow rate of the lubricant oil flowing through each of the oil air supply pipelines after being distributed by the mixing device, it is possible to accurately measure the change in the flow rate of the lubricant oil and to surely detect supply abnormality of the lubricant oil by the abnormality detection device.

Further, according to the oil air supply system of 1), it is only necessary to install the flow rate sensor in the lubricant oil supply pipeline, and thus the cost can be reduced as compared with the conventional technique in which it was necessary to provide a sensor in each of a plurality of oil air supply pipelines. Moreover, according to the oil air supply system of 1), since the flow rate of the lubricant oil to be detected is large, it is not necessary to use an optical sensor as in the conventional technique for the flow rate sensor provided in the lubricant oil supply pipeline. Therefore, there is no need to frequently perform maintenance or replacement of each of the oil air supply pipeline as well as the lubricant oil supply pipeline in order to maintain detection accuracy, and the workload is reduced.

According to the oil air supply system of 2), in addition to the detection of supply abnormality of the lubricant oil, the pressure of the compressed air for conveying the lubricant oil is detected by the pressure sensor provided in the compressed air supply pipeline, and by detecting supply abnormality of the compressed air by the abnormality detection device which has received an output signal from the pressure sensor, it is possible to detect supply abnormality of the oil air more accurately.

Further, according to the oil air supply system of 2), since both the detection of supply abnormality of the lubricant oil and the detection of the supply abnormality of the compressed air are performed by the abnormality detection device, the structure of the system is simplified, and measures based on the abnormality detection can be taken systematically.

### BRIEF DESCRIPTION OF THE DRAWINGS

FIG. 1 is an illustrative diagram showing an oil air supply system according to an embodiment of the invention.

### DETAILED DESCRIPTION OF THE INVENTION

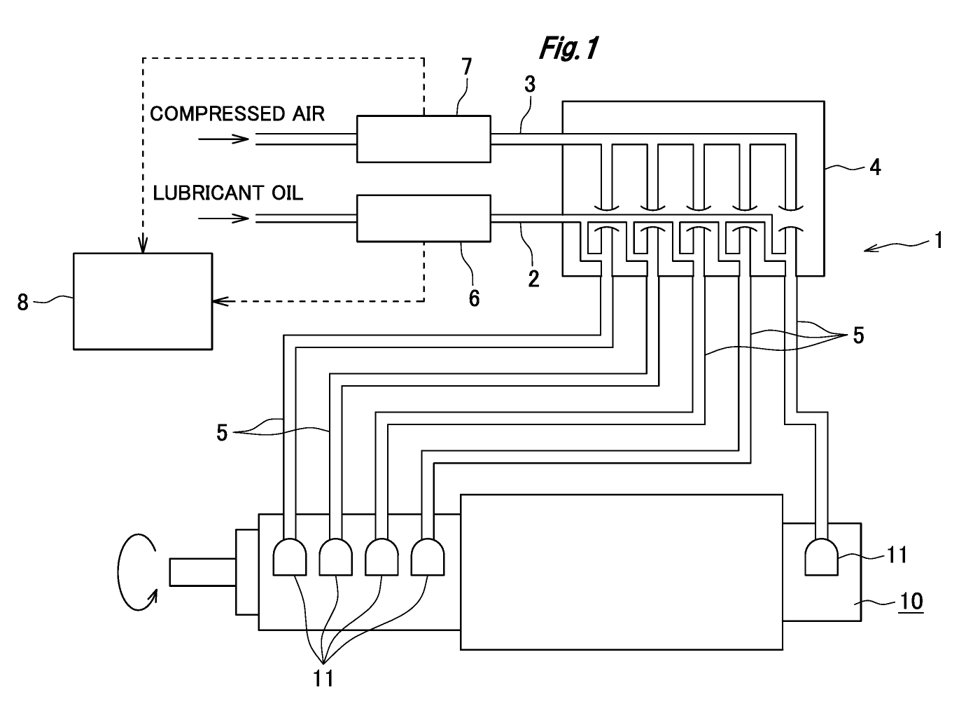

Hereinafter, the oil air supply system according to an embodiment of the invention will be described in detail with reference to FIG. 1.

In this embodiment, the invention is applied to an oil air supply system in a main spindle device of a machine tool.

As shown in FIG. 1, an oil air supply system (1) includes a lubricant oil supply pipeline (2), a compressed air supply pipeline (3), a mixing device (4) which distributes lubricant oil supplied from the lubricant oil supply pipeline (2) in a fixed amount and mixes the lubricant oil with compressed air supplied from the compressed air supply pipeline (3) to generate oil air, a plurality (five in this case) of oil air supply pipelines (5) which supply the oil air to a plurality (five in this case) of bearings (lubricating points) (11) of a main spindle device (10) respectively, a flow rate sensor (6) which is provided in the lubricant oil supply pipeline (2) and detects the flow rate of the lubricant oil, a pressure sensor (7) which is provided in the compressed air supply pipeline (3) and detects the pressure of the compressed air, and an abnormality detection device (8) which detects supply abnormality of lubricant oil based on a detection signal output from the flow rate sensor (6) and detects supply abnormality of compressed air based on a detection signal output from the pressure sensor (7).

The lubricant oil supply pipeline (2) extends from a lubricant oil supply source which is not shown in the drawing, and its distal end side is connected to the mixing device (4).

The compressed air supply pipeline (3) extends from a compressed air supply source which is not shown in the drawing, and its distal end side is connected to the mixing device (4).

In the mixing device (4), the lubricant oil supply pipeline (2) and the compressed air supply pipeline (3) are respectively branched into a plurality (five in this case) of pipelines, and each branch pipeline of the lubricant oil is merged into each branch pipeline of the compressed air. A quantifier (not shown in the drawing) is provided in each branch pipeline of the lubricant oil. With this quantifier, the lubricant oil is supplied to each branch pipeline of the compressed air in a fixed amount (for example, about 0.01 to 0.03 cc), and by mixing the lubricant oil with the compressed air here, oil air is generated.

The base end side of each oil air supply pipeline (5) is connected to the outlet end of each branch pipeline of the compressed air in the mixing device (4), and the distal end side is connected to the vicinity of each bearing (11) of the main spindle device (10).

The flow rate sensor (6) is not particularly limited as long as it is suitable for detection of the flow rate of the lubricant oil flowing through the lubricant oil supply pipeline (2). The position at which the flow rate sensor (6) is to be installed is also not particularly limited as long as it is within the lubricant oil supply pipeline (2).

The pressure sensor (7) is not particularly limited as long as it is suitable for detection of the pressure of the compressed air flowing through the compressed air supply pipeline (3). The position at which the pressure sensor (7) is to be installed is also not particularly limited as long as it is within the compressed air supply pipeline (3).

In the abnormality detection device (8), a detection signal of the flow rate of the lubricant oil output from the flow rate sensor (6) is received via a wiring or received wirelessly and is compared with a preset flow rate range of a normal state, and when it is out of the range, it is determined that the supply of the lubricant oil is abnormal.

Further, in the abnormality detection device (8), a detection signal of the pressure of the compressed air output from the pressure sensor (7) is received via a wiring or received wirelessly and is compared with a preset pressure range of a normal state, and when it is out of the range, it is determined that the supply of the compressed air is abnormal.

When the abnormality detection device (8) determines that the supply of at least one of the lubricant oil and the compressed air is abnormal, it will notify an operator of the abnormality by, for example, a monitor display or an alarm sound. At the same time, an abnormality signal may be sent from the abnormality detection device (8) to a drive control device (not shown in the drawing) of the main spindle device (10) such that the main spindle device (10) is automatically stopped.

The invention is suitably used as an oil air supply system for supplying oil air to a plurality of lubricating points in, for example, a main spindle device and the like which perform lubrication of a plurality of lubricating points such as bearings by oil air lubrication.

What is claimed is:

1. An oil air supply system comprising
a lubricant oil supply pipeline,
a compressed air supply pipeline,
a mixing device which distributes lubricant oil supplied from the lubricant oil supply pipeline in a fixed amount and mixes the lubricant oil with compressed air supplied from the compressed air supply pipeline to generate oil air,
a plurality of oil air supply pipelines which supply the oil air to a plurality of lubricating points respectively,
a flow rate sensor which is provided in the lubricant oil supply pipeline and detects the flow rate of the lubricant oil, and
an abnormality detection device which detects supply abnormality of lubricant oil based on a detection signal output from the flow rate sensor.

2. The oil air supply system according to claim 1, further comprising a pressure sensor which is provided in the compressed air supply pipeline and detects the pressure of the compressed air, wherein the abnormality detection device detects supply abnormality of compressed air based on a detection signal output from the pressure sensor.
